(19) United States
(12) Patent Application Publication
(10) Pub. No.: US 2019/0225799 A1
(43) Pub. Date: Jul. 25, 2019

(54) POLY(PHENYLENE ETHER) COMPOSITION AND ARTICLE, AND METHOD OF REDUCING ODOR OF A POLY(PHENYLENE ETHER) COMPOSITION

(71) Applicant: SABIC Global Technologies B.V., Bergen op Zoom (NL)

(72) Inventors: Hui Peng, Shanghai (CN); Zhenke Wei, Shanghai (CN); Jian Yang, Shanghai (CN)

(21) Appl. No.: 16/313,540

(22) PCT Filed: Jun. 17, 2017
(86) PCT No.: PCT/IB2017/053609

§ 371 Date: Dec. 27, 2018

Related U.S. Application Data
(60) Provisional application No. 62/355,977, filed on Jun. 29, 2016.

(51) Int. Cl. C08L 71/12; C08K 3/32

(52) U.S. Cl. CPC C08L 71/126; C08K 3/32; C08K 2003/324; C08L 23/26; C08K 2003/326; C08K 2003/328; C08K 2003/325

(57) ABSTRACT

The undesirable odor of poly(phenylene ether) has discouraged its adoption for some end uses. Melt-blending poly(phenylene ether) with a small amount of a phosphate salt or its hydrate is found to substantially reduce the odor without affecting physical or thermal properties. The odor-reduction method is applicable to poly(phenylene ether) alone or in combination with other resins.

### BACKGROUND OF THE INVENTION

Poly(phenylene ether) is known to have an unpleasant odor, and various means of reducing the odor have been disclosed.

U.S. Pat. No. 4,992,222 to Banevicius et al. describes passing poly(phenylene ether) or poly(phenylene ether)/polystyrene compositions through an extruder with water injection and vacuum venting to remove volatile substances, including those with strong odors.

U.S. Pat. No. 5,017,656 to Bopp describes reducing the odor of poly(phenylene ether), alone or in combination with a polystyrene or a high impact polystyrene, by melt blending the composition with a carboxylic acid, an acid anhydride, or a mixture thereof.

U.S. Pat. No. 6,306,953 to Fortuyn et al. describes reducing emissions of styrene, butanal, and their associated odors by melt blending a poly(phenylene ether), a polystyrene, and optional rubber in the presence of an activated carbon derived from vegetable matter.

There remains a need for alternative methods of reducing the odor of poly(phenylene ether)-containing compositions.

### BRIEF SUMMARY OF EMBODIMENTS OF THE INVENTION

One embodiment is a composition comprising the product of melt blending components comprising: 100 parts by weight of a poly(phenylene ether); and 0.1 to 4 parts by weight of a phosphate salt selected from the group consisting of sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates; wherein all parts by weight are based on 100 parts by weight of the poly(phenylene ether).

Another embodiment is an article comprising the composition in any of its variations.

Another embodiment is a method of reducing the odor of a poly(phenylene ether) composition, the method comprising melt blending 100 parts by weight of a poly(phenylene ether), and 0.1 to 4 parts by weight of a phosphate salt selected from the group consisting of sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates; wherein all parts by weight are based on 100 parts by weight of the poly(phenylene ether).

These and other embodiments are described in detail below.

### DETAILED DESCRIPTION OF THE INVENTION

The present inventors have determined that certain phosphate salts and their hydrates are effective for reducing the odor associated with poly(phenylene ether). This odor reduction method is applicable when the poly(phenylene ether) is alone, or when the poly(phenylene ether) is combined with one or more additional resins, including, for example, homopolystyrenes, rubber-modified polystyrenes, unhydrogenated block copolymers of an alkenyl aromatic monomer and a conjugated diene, hydrogenated block copolymers of an alkenyl aromatic monomer and a conjugated diene, polyamides, polyesters, and polyolefins.

One embodiment is a composition comprising the product of melt blending components comprising: 100 parts by weight of a poly(phenylene ether), and 0.1 to 4 parts by weight of a phosphate salt selected from the group consisting of sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates; wherein all parts by weight are based on 100 parts by weight of the poly(phenylene ether). The composition is described as “the product of melt blending components” because the chemical composition of the melt blended composition may differ from that of some of the components prior to melt blending. For example, melt blending can cause an increase in the intrinsic viscosity of the poly(phenylene ether). As another example, a dihydrogen phosphate ion (H₂PO₄⁻) present before melt blending may exist in a different form (e.g., H₃PO₄ or HPO₄²⁻) in the melt blended composition.

The melt blended components include a poly(phenylene ether). Poly(phenylene ether)s include those comprising repeating structural units having the formula

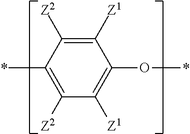

wherein each occurrence of Z¹ is independently halogen, unsubstituted or substituted C1-C12 hydrocarbyl provided that the hydrocarbyl group is not tertiary hydrocarbyl, C1-C12 hydrocarbylthio, C₁-C₁2 hydrocarbyloxy, or C₂-C₁2 halohydrocarbyloxy wherein at least two carbon atoms separate the halogen and oxygen atoms; and each occurrence of Z² is independently hydrogen, halogen, unsubstituted or substituted C₁-C₁2 hydrocarbyl provided that the hydrocarbyl group is not tertiary hydrocarbyl, C₁-C₁₂ hydrocarbylthio, C₁-C₁₂ hydrocarbyloxy, or C₂-C₁2 halohydrocarbyloxy wherein at least two carbon atoms separate the halogen and oxygen atoms. As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. As one example, Z¹ can be a di-n-butylaminomethyl group formed by reaction of a terminal 3,5-dimethyl-1,4-phenyl group with the di-n-butylamine component of an oxidative polymerization catalyst.

The poly(phenylene ether) can comprise molecules having aminoalkyl-containing end group(s), typically located in a position ortho to the hydroxyl group. Also frequently present are tetramethyldiphenoquinone (TMDQ) end groups, typically obtained from 2,6-dimethylphenol-containing reaction mixtures in which tetramethyldiphenoquinone by-product is present. The poly(phenylene ether) can be in the form of a homopolymer, a copolymer, a graft copolymer, an ionomer, or a block copolymer, as well as combinations thereof.

In some embodiments, the poly(phenylene ether) comprises a poly(phenylene ether)-polysiloxane block copolymer. As used herein, the term “poly(phenylene ether)-polysiloxane block copolymer” refers to a block copolymer comprising at least one poly(phenylene ether) block and at least one polysiloxane block.

In some embodiments, the poly(phenylene ether)-polysiloxane block copolymer is prepared by an oxidative copolymerization method. In this method, the poly(phenylene ether)-polysiloxane block copolymer is the product of a process comprising oxidatively copolymerizing a monomer mixture comprising a monohydric phenol and a hydroxyaryl-terminated polysiloxane. In some embodiments, the monomer mixture comprises 70 to 99 parts by weight of the monohydric phenol and 1 to 30 parts by weight of the hydroxyaryl-terminated polysiloxane, based on the total weight of the monohydric phenol and the hydroxyaryl-terminated polysiloxane. The hydroxyaryl-diterminated polysiloxane can comprise a plurality of repeating units having the structure

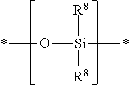

wherein each occurrence of R⁸ is independently hydrogen, C₁-C₁₂ hydrocarbyl or C₁-C₁₂ halohydrocarbyl; and two terminal units having the structure

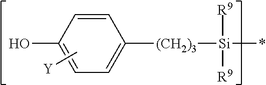

wherein Y is hydrogen, C₁-C₁₂ hydrocarbyl, C₁-C₁₂ hydrocarbyloxy, or halogen, and wherein each occurrence of R⁹ is independently hydrogen, C₁-C₁₂ hydrocarbyl or C₁-C₁₂ halohydrocarbyl. In a very specific embodiment, each occurrence of R⁸ and R⁹ is methyl, and Y is methoxyl.

In some embodiments, the monohydric phenol comprises 2,6-dimethylphenol, and the hydroxyaryl-terminated polysiloxane has the structure

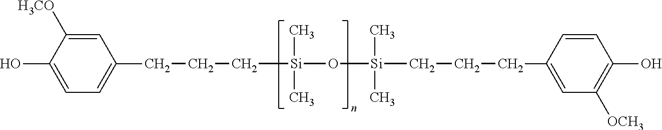

wherein n is, on average, 5 to 100, specifically 30 to 60.

The oxidative copolymerization method produces poly(phenylene ether)-polysiloxane block copolymer as the desired product and poly(phenylene ether) (without an incorporated polysiloxane block) as a by-product. It is not necessary to separate the poly(phenylene ether) from the poly(phenylene ether)-polysiloxane block copolymer. The poly(phenylene ether)-polysiloxane block copolymer can thus be utilized as a “reaction product” that includes both the poly(phenylene ether) and the poly(phenylene ether)-polysiloxane block copolymer. Certain isolation procedures, such as precipitation from isopropanol, make it possible to assure that the reaction product is essentially free of residual hydroxyaryl-terminated polysiloxane starting material. In other words, these isolation procedures assure that the polysiloxane content of the reaction product is essentially all in the form of poly(phenylene ether)-polysiloxane block copolymer. Detailed methods for forming poly(phenylene ether)-polysiloxane block copolymers are described in U.S. Pat. Nos. 8,017,697 and 8,669,332 to Carrillo et al.

In some embodiments, the poly(phenylene ether) has an intrinsic viscosity of 0.25 to 1 deciliter per gram measured by Ubbelohde viscometer at 25° C. in chloroform. Within this range, the poly(phenylene ether) intrinsic viscosity can be 0.3 to 0.65 deciliter per gram, more specifically 0.35 to 0.5 deciliter per gram, even more specifically 0.4 to 0.5 deciliter per gram.

In some embodiments, the poly(phenylene ether) comprises a homopolymer or copolymer of monomers selected from the group consisting of 2,6-dimethylphenol, 2,3,6-trimethylphenol, and combinations thereof. In some embodiments, the poly(phenylene ether) comprises a poly(phenylene ether)-polysiloxane block copolymer. In these embodiments, the poly(phenylene ether)-polysiloxane block copolymer can, for example, contribute 0.05 to 2 weight percent, specifically 0.1 to 1 weight percent, more specifically 0.2 to 0.8 weight percent, of siloxane groups to the composition as a whole.

Suitable poly(phenylene ether) homopolymers are commercially available as, for example, PPO™ 640 and 646 from SABIC. A poly(phenylene ether)-polysiloxane block copolymer is commercially available as PPO™ 843 Resin from SABIC.

In some embodiments, the poly(phenylene ether) comprises a maleic anhydride-functionalized poly(phenylene ether). The maleic anhydride-functionalized poly(phenylene ether) can be prepared by reacting 0.1 to 10 parts by weight maleic anhydride with 100 parts by weight unfunctionalized poly(phenylene ether) in the presence or absence of solvent. The maleic anhydride-functionalized poly(phenylene ether) can be used as the sole poly(phenylene ether), or it can be used in combination with unfunctionalized poly(phenylene ether). In a subset of the latter embodiments, the poly(phenylene ether) comprises 1 to 30 parts by weight of maleic anhydride-functionalized poly(phenylene ether) per 100 parts by weight total of maleic anhydride-functionalized poly(phenylene ether) and unfunctionalized poly(phenylene ether). Within this range, the maleic anhydride-functionalized poly(phenylene ether) amount can be 2 to 20 parts by weight, or 4 to 15 parts by weight.

The melt blended components comprise the poly(phenylene ether) in an amount of 100 parts by weight, and all other component amounts are expressed in parts by weight based on 100 parts by weight of the poly(phenylene ether).

In addition to the poly(phenylene ether), the melt-blended components comprise a phosphate salt. The term “phosphate salt” includes salts of pyrophosphate ion in addition to salts of phosphate ion. Suitable phosphate salts include sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates. As demonstrated in the working examples below, phosphate salts are effective to reduce the odor associated with poly(phenylene ether). The phosphate salts described herein are commercially available, and methods for their preparation are known.

The melt blended components comprise the phosphate salt in an amount of 0.1 to 4 parts by weight, based on 100 parts by weight of the poly(phenylene ether). Within this range, the phosphate salt amount can be 0.1 to 2 parts by weight, or 0.1 to 1 part by weight, or 0.2 to 0.8 part by weight, or 0.2 to 0.6 part by weight.

The melt-blended components can, optionally, further include additional compounds that further reduce the odor of the poly(phenylene ether). For example, in some embodiments, the melt-blended components further comprise 0.1 to 5 parts by weight of maleic anhydride, per 100 parts by weight of the poly(phenylene ether). Within this range, the maleic anhydride amount can be 0.1 to 3 parts by weight, or 0.2 to 2 parts by weight.

Maleic anhydride-functionalized polymers can further reduce the odor of the poly(phenylene ether). One example of such a polymer is the maleic anhydride-functionalized poly(phenylene ether) described above. Another example is a maleic anhydride-functionalized ethylene / alpha-olefin copolymer. In this copolymer, the alpha-olefin can be, for example, a linear C₄-C₁₂ alpha-olefin, such as 1-butene, 1-hexene, 1-octene, 1-decene, or 1-dodecene. In some embodiments, the maleic anhydride-functionalized ethylene/alpha-olefin copolymer is a maleic anhydride-functionalized ethylene/1-octene copolymer. The maleic anhydride content of the maleic anhydride-functionalized ethylene/alpha-olefin copolymer can be 0.5 to 20 weight percent, or 1 to 10 weight percent, based on the weight of the maleic anhydride-functionalized ethylene/alpha-olefin copolymer. Maleic anhydride-functionalized ethylene/alpha-olefin copolymers are commercially available as, for example FUSABOND™ N493 from DuPont. When present among the melt blended components, the maleic anhydride-functionalized ethylene/alpha-olefin copolymer can be used in an amount of 5 to 400 parts by weight, based on 100 parts by weight of the poly(phenylene ether). Within this range, the maleic anhydride-functionalized ethylene/alpha-olefin copolymer amount can be 5 to 200 parts by weight, or 5 to 150 parts by weight, or 20 to 120 parts by weight. In some embodiments in which the melt blended components comprise the maleic anhydride-functionalized ethylene/alpha-olefin copolymer, they further comprise 5 to 400 parts by weight of an unfunctionalized ethylene/alpha-olefin copolymer. Within this range, the unfunctionalized ethylene/alpha-olefin copolymer amount can be 5 to 200 parts by weight, or 10 to 180 parts by weight, or 30 to 160 parts by weight. Unfunctionalized ethylene/alpha-olefin copolymers are commercially available as, for example, QUEO™ 8201 and 8210 from Borealis.

Another compound that can be used for supplemental odor reduction is a maleic anhydride-functionalized hydrogenated block copolymer of an alkenyl aromatic monomer and a conjugated diene (maleic anhydride-functionalized hydrogenated block copolymer). The maleic anhydride-functionalized hydrogenated block copolymer is the product of reacting maleic anhydride with a hydrogenated block copolymer of an alkenyl aromatic monomer and a conjugated diene (hydrogenated block copolymer). The hydrogenated block copolymer can comprise 10 to 90 weight percent of poly(alkenyl aromatic) content and 90 to 10 weight percent of hydrogenated poly(conjugated diene) content, based on the weight of the hydrogenated block copolymer. In some embodiments, the hydrogenated block copolymer is a low poly(alkenyl aromatic content) hydrogenated block copolymer in which the poly(alkenyl aromatic) content is 10 to less than 40 weight percent, specifically 20 to 35 weight percent, more specifically 25 to 35 weight percent, yet more specifically 30 to 35 weight percent, all based on the weight of the low poly(alkenyl aromatic) content hydrogenated block copolymer. In other embodiments, the hydrogenated block copolymer is a high poly(alkenyl aromatic content) hydrogenated block copolymer in which the poly(alkenyl aromatic) content is 40 to 90 weight percent, specifically 50 to 80 weight percent, more specifically 60 to 70 weight percent, all based on the weight of the high poly(alkenyl aromatic content) hydrogenated block copolymer.

In some embodiments, the hydrogenated block copolymer has a weight average molecular weight of 40,000 to 400,000 grams per mole. The number average molecular weight and the weight average molecular weight can be determined by gel permeation chromatography and based on comparison to polystyrene standards. In some embodiments, the hydrogenated block copolymer has a weight average molecular weight of 200,000 to 400,000 grams per mole, specifically 220,000 to 350,000 grams per mole. In other embodiments, the hydrogenated block copolymer has a weight average molecular weight of 40,000 to 200,000 grams per mole, specifically 40,000 to 180,000 grams per mole, more specifically 40,000 to 150,000 grams per mole.

The alkenyl aromatic monomer used to prepare the hydrogenated block copolymer can have the structure

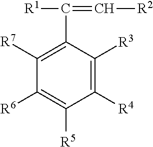

wherein R¹ and R² each independently represent a hydrogen atom, a C₁-C₈ alkyl group, or a C₂-C₈ alkenyl group; R³ and R⁷ each independently represent a hydrogen atom, a C₁-C₈ alkyl group, a chlorine atom, or a bromine atom; and R⁴, R⁵, and R⁶ each independently represent a hydrogen atom, a C₁-C₈ alkyl group, or a C₂-C₈ alkenyl group, or R⁴ and R⁵ are taken together with the central aromatic ring to form a naphthyl group, or R⁵ and R⁶ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In some embodiments, the alkenyl aromatic monomer is styrene.

The conjugated diene used to prepare the hydrogenated block copolymer can be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In some embodiments, the conjugated diene is 1,3-butadiene, 2-methyl-1,3-butadiene, or a combination thereof. In some embodiments, the conjugated diene is 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In some embodiments, the aliphatic unsaturation in the (B) block is reduced by at least 50 percent, specifically at least 70 percent. The arrangement of blocks (A) and (B) includes a linear structure, a grafted structure, and a radial teleblock structure with or without a branched chain. Linear block copolymers include tapered linear structures and non-tapered linear structures. In some embodiments, the hydrogenated block copolymer has a tapered linear structure. In some embodiments, the hydrogenated block copolymer has a non-tapered linear structure. In some embodiments, the hydrogenated block copolymer comprises a (B) block that comprises random incorporation of alkenyl aromatic monomer. Linear block copolymer structures include diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of (A) and (B), wherein the molecular weight of each (A) block can be the same as or different from that of other (A) blocks, and the molecular weight of each (B) block can be the same as or different from that of other (B) blocks. In some embodiments, the hydrogenated block copolymer is a diblock copolymer, a triblock copolymer, or a combination thereof.

Methods for preparing hydrogenated block copolymers are known in the art and many hydrogenated block copolymers are commercially available. Illustrative commercially available hydrogenated block copolymers include the polystyrene-poly(ethylene-propylene) diblock copolymers available from Kraton Performance Polymers Inc. as KRATON™ G1701 (having about 37 weight percent polystyrene) and G1702 (having about 28 weight percent polystyrene); the polystyrene-poly(ethylene-butylene)-polystyrene triblock copolymers available from Kraton Performance Polymers Inc. as KRATON™ G1641 (having about 33 weight percent polystyrene), G1650 (having about 30 weight percent polystyrene), G1651 (having about 33 weight percent polystyrene), and G1654 (having about 31 weight percent polystyrene); and the polystyrene-poly(ethylene-ethylene/propylene)-polystyrene triblock copolymers available from Kuraray as SEPTON™ S4044, S4055, S4077, and S4099. Additional commercially available hydrogenated block copolymers include polystyrene-poly(ethylene-butylene)-polystyrene (SEBS) triblock copolymers available from Dynasol as CALPRENE™ H₆₁₄₀ (having about 31 weight percent polystyrene), H₆₁₇₀ (having about 33 weight percent polystyrene), H₆₁₇₁ (having about 33 weight percent polystyrene), and H₆₁₇₄ (having about 33 weight percent polystyrene); and from Kuraray as SEPTON™ 8006 (having about 33 weight percent polystyrene) and 8007 (having about 30 weight percent polystyrene); polystyrene-poly(ethylene-butylene-styrene)-polystyrene tapered block copolymers available from Kraton Performance Polymers as KRATON™ A1535 (having 56.3-60.3 weight percent polystyrene) and A1536 (having 37-44 weight percent polystyrene); polystyrene-poly(ethylene-propylene)-polystyrene (SEPS) copolymers available from Kuraray as SEPTON™ 2006 (having about 35 weight percent polystyrene) and 2007 (having about 30 weight percent polystyrene). Mixtures of two of more hydrogenated block copolymers can be used. In some embodiments, the hydrogenated block copolymer comprises a polystyrene-poly(ethylene-butylene)-polystyrene triblock copolymer having a weight average molecular weight of at least 100,000 grams per mole.

As noted above, the maleic anhydride-functionalized hydrogenated block copolymer is the product of reacting maleic anhydride with a hydrogenated block copolymer. The reaction can be conducted in the presence or absence of a solvent. The maleic anhydride content of the maleic anhydride-functionalized hydrogenated block copolymer can be 0.5 to 20 weight percent, or 1 to 10 weight percent, based on the weight of the maleic anhydride-functionalized hydrogenated block copolymer. Maleic anhydride-functionalized hydrogenated block copolymers are commercially available as, for example, KRATON™ FG 1901 and 1924 from Kraton Performance Polymers. When present among the melt-blended components, the maleic anhydride-functionalized hydrogenated block copolymer can be used in an amount of 5 to 400 parts by weight, per 100 parts by weight of the poly(phenylene ether). Within this range, the maleic anhydride-functionalized hydrogenated block copolymer amount can be 5 to 200 parts by weight, or 5 to 100 parts by weight, or 5 to 50 parts by weight, or 10 to 40 parts by weight. In some embodiment in which the melt-blended components comprise the maleic anhydride-functionalized hydrogenated block copolymer, they further comprise 10 to 400 parts by weight of an unfunctionalized hydrogenated block copolymer of an alkenyl aromatic monomer and a conjugated diene, per 100 parts by weight of the poly(phenylene ether). Within this range, the unfunctionalized hydrogenated block copolymer amount can be 10 to 200 parts by weight, or 20 to 180 parts by weight, or 40 to 160 parts by weight. The term “unfunctionalized hydrogenated block copolymer” has the same meaning as “hydrogenated block copolymer”, which is described above.

Whether or not supplemental odor-reducing compounds are present, the melt-blended components can comprise, in addition to the poly(phenylene ether) and the phosphate salt, one or more thermoplastic resins other than the poly(phenylene ether).

For example, in some embodiments, the melt-blended components comprise, in addition to the poly(phenylene ether) and the phosphate salt, 10 to 400 parts by weight of homopolystyrene, rubber-modified polystyrene, or a combination thereof, based on 100 parts by weight of the poly(phenylene ether). Within this range, the amount of the homopolystyrene, rubber-modified polystyrene, or a combination thereof can be 20 to 300 parts by weight, or 40 to 200 parts by weight. As used herein, the term homopolystyrene refers to a homopolymer of styrene. Thus, the residue of any monomer other than styrene is excluded from the homopolystyrene. The homopolystyrene can be atactic, syndiotactic, or isotactic. In some embodiments, the homopolystyrene consists of atactic homopolystyrene. The term “rubber-modified polystyrene” refers to polystyrene and polybutadiene grafted to each other and/or in a physical mixture. Rubber-modified polystyrenes are sometimes referred to as “high-impact polystyrenes” or “HIPS”. In some embodiments, the rubber-modified polystyrene comprises 80 to 96 weight percent polystyrene, or 88 to 94 weight percent polystyrene; and 4 to 20 weight percent polybutadiene, or 6 to 12 weight percent polybutadiene, based on the weight of the rubber-modified polystyrene.

In some embodiments, the melt-blended components comprise, in addition to the poly(phenylene ether) and the phosphate salt, 100 to 900 parts by weight of a polyamide, based on 100 parts by weight of the poly(phenylene ether). Within this range, the polyamide amount can be 200 to 800 parts by weight, or 300 to 700 parts by weight. Polyamides, also known as nylons, are characterized by the presence of a plurality of amide (—C(O)NH—) groups and are described in U.S. Pat. No. 4,970,272 to Gallucci. Suitable polyamides include polyamide-6, polyamide-6,6, polyamide-4,6, polyamide-11, polyamide-12, polyamide-6,10, polyamide-6,12, polyamide 6/6,6, polyamide-6/6,12, polyamide MXD,6 (where MXD is m-xylylene diamine), polyamide-6,T, polyamide-6,I, polyamide-6/6,T, polyamide-6/6,I, polyamide-6,6/6,T, polyamide-6,6/6,I, polyamide-6/6,T/6,I, polyamide-6,6/6,T/6,I, polyamide-6/12/6,T, polyamide-6,6/12/6,T, polyamide-6/12/6,I, polyamide-6,6/12/6,I, or a combination thereof. In some embodiments, the polyamide comprises a polyamide-6,6. In some embodiments, the polyamide comprises a polyamide-6 and a polyamide-6,6. In some embodiments, the polyamide or combination of polyamides has a melting point (Tₘ) greater than or equal to 171° C. In some embodiments, the polyamide has an amine end group concentration greater than or equal to 35 microequivalents amine end groups per gram of polyamide (μ) as determined by titration with hydrochloric acid (HCl). The amine end group concentration can be greater than or equal to 40 μeq/g, or, more specifically, greater than or equal to 45 μeq/g Amine end group content can be determined by dissolving the polyamide in a suitable solvent, optionally with heat. The polyamide solution is titrated with 0.01 Normal HCl solution using a suitable indication method. The amount of amine end groups is calculated based the volume of HCl solution added to the sample, the volume of HCl used for the blank, the molarity of the HCl solution, and the weight of the polyamide sample.

In some embodiments, the melt-blended components comprise, in addition to the poly(phenylene ether) and the phosphate salt, 20 to 400 parts by weight of an ethylene homopolymer, a propylene homopolymer, or a combination thereof, based on 100 parts by weight of the poly(phenylene ether). Within this range, the amount of ethylene homopolymer, propylene homopolymer, or combination thereof can be 20 to 200 parts by weight, or 30 to 150 parts by weight, or 40 to 120 parts by weight.

In some embodiments, the melt-blended components comprise, in addition to the poly(phenylene ether) and the phosphate salt, 10 to 400 parts by weight of a hydrogenated block copolymer of an alkenyl aromatic monomer and a conjugated diene, based on 100 parts by weight of the poly(phenylene ether). Within this range, the hydrogenated block copolymer amount can be 10 to 200 parts by weight, or 20 to 180 parts by weight, or 40 to 160 parts by weight. The hydrogenated block copolymer is described above in the context of the maleic anhydride-functionalized hydrogenated block copolymer. However, the present embodiments are independent of the presence or absence of the maleic anhydride-functionalized hydrogenated block copolymer.

In a very specific embodiment, in addition to the poly(phenylene ether) and the phosphate salt, the melt blended components comprise 5 to 300 parts by weight of an unfunctionalized ethylene/alpha-olefin copolymer, a maleic anhydride-functionalized ethylene/alpha-olefin copolymer, or a combination thereof; and 10 to 200 parts by weight of an unfunctionalized hydrogenated block copolymer of an alkenyl aromatic monomer and a conjugated diene, a maleic anhydride-functionalized hydrogenated block copolymer of an alkenyl aromatic monomer and a conjugated diene, or a combination thereof. These part by weight ranges are based on 100 parts by weight of the poly(phenylene ether). Within the range of 5 to 300 parts by weight, the amount of unfunctionalized ethylene/alpha-olefin copolymer, maleic anhydride-functionalized ethylene/alpha-olefin copolymer, or combination thereof can be 10 to 200 parts by weight, or 20 to 150 parts by weight. Within the range of 10 to 200 parts by weight, the amount of the unfunctionalized hydrogenated block copolymer of an alkenyl aromatic monomer and a conjugated diene, maleic anhydride-functionalized hydrogenated block copolymer of an alkenyl aromatic monomer and a conjugated diene, a combination thereof can be 20 to 180 parts by weight, or 40 to 160 parts by weight.

In addition to the poly(phenylene ether) and the phosphate salt, the melt blended components can optionally comprise one or more additives known in the thermoplastics art. For example, the melt-blended components can, optionally, further comprise an additive selected from the group consisting of stabilizers, mold release agents, lubricants, processing aids, drip retardants, nucleating agents, UV blockers, dyes, pigments, antioxidants, anti-static agents, blowing agents, mineral oil, metal deactivators, antiblocking agents, and combinations thereof. When present, such additives are typically used in a total amount of less than or equal to 10 parts by weight, or less than 5 parts by weight, based on 100 parts by weight of the poly(phenylene ether). However, when the additives include white pigment, their total amount can be up to 30 parts by weight, based on 100 parts by weight of the poly(phenylene ether).

In some embodiments, the melt-blended components exclude polycarbonates. In some embodiments, the melt blended-components exclude polyesters. In some embodiments, the melt-blended components exclude polycarbonates and polyesters.

The composition can be prepared by melt-blending the components. The melt-blending can be performed using common equipment such as ribbon blenders, HENSCHEL™ mixers, BANBURY™ mixers, drum tumblers, single-screw extruders, twin-screw extruders, multi-screw extruders, and co-kneaders. Particular melt-blending conditions will dependent on the melt-blended components and their amounts. For example, when the melt-blended components include rubber-modified polystyrene, melt-blending can be conducted the components in a twin-screw extruder at a temperature of 240 to 260° C., or 245 to 255° C.

The composition is useful for molding articles, especially articles with which humans and/or companion animals have olfactory encounters. Such articles include automotive interior parts, aviation interior parts, insulation and/or jacket for wire and cable (e.g., as used in consumer electronics), food storage containers, food serving containers, exercise equipment, office equipment, and fluid engineering articles. In some embodiments, the article is insulation and/or jacket for wire and cable. Suitable methods of forming such articles include single layer and multilayer sheet extrusion, injection molding, blow molding, film extrusion, profile extrusion, pultrusion, compression molding, thermoforming, pressure forming, hydroforming, and vacuum forming. Combinations of the foregoing article fabrication methods can be used. All of the above-described variations of the composition apply as well to the articles comprising the composition.

Another embodiment is a method of reducing the odor of a poly(phenylene ether) composition, the method comprising melt blending 100 parts by weight of a poly(phenylene ether), and 0.1 to 4 parts by weight of a phosphate salt selected from the group consisting of sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates; wherein all parts by weight are based on 100 parts by weight of the poly(phenylene ether). As described above in the context of the composition, additional components can be melt-blended with the poly(phenylene ether) and the phosphate salt.

The invention includes at least the following embodiments.

### Embodiment 1

A composition comprising the product of melt blending components comprising: 100 parts by weight of a poly(phenylene ether), and 0.1 to 4 parts by weight of a phosphate salt selected from the group consisting of sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates; wherein all parts by weight are based on 100 parts by weight of the poly(phenylene ether).

### Embodiment 2

The composition of embodiment 1, wherein the poly(phenylene ether) comprises repeating structural units having the formula

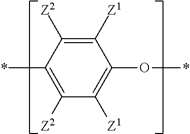

wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁2 hydrocarbyloxy, or C₂-C₁2 halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

### Embodiment 3

The composition of embodiment 1, wherein the poly(phenylene ether) comprises a homopolymer or copolymer of monomers selected from the group consisting of 2,6-dimethylphenol and 2,3,6-trimethylphenol.

### Embodiment 4

The composition of any one of embodiments 1-3, wherein the poly(phenylene ether) comprises a maleic anhydride-functionalized poly(phenylene ether).

### Embodiment 5

The composition of any one of embodiments 1-4, wherein the phosphate salt is selected from the group consisting of zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates.

### Embodiment 6

The composition of any one of embodiments 1-4, wherein the phosphate salt is zinc bis(dihydrogen phosphate) (Zn(H₂PO₄)₂), a hydrate thereof, or a combination of the foregoing salt and the hydrate.

### Embodiment 7

The composition of any one of embodiments 1-6, wherein the melt-blended components further comprise 0.1 to 5 parts by weight of maleic anhydride.

### Embodiment 8

The composition of any one of embodiments 1-7, wherein the melt-blended components further comprise 5 to 400 parts by weight of a maleic anhydride-functionalized ethylene/alpha-olefin copolymer.

### Embodiment 9

The composition of embodiment 8, wherein the melt-blended components further comprise 5 to 400 parts by weight of an unfunctionalized ethylene/alpha-olefin copolymer.

### Embodiment 10

The composition of any one of embodiments 1-9, wherein the melt-blended components further comprise 5 to 400 parts by weight of a maleic anhydride-functionalized hydrogenated block copolymer of an alkenyl aromatic monomer and a conjugated diene.

### Embodiment 11

The composition of embodiment 10, wherein the melt-blended components further comprise 10 to 400 parts by weight of an unfunctionalized hydrogenated block copolymer of an alkenyl aromatic monomer and a conjugated diene.

### Embodiment 12

The composition of any one of embodiments 1-11, wherein the melt-blended components further comprise 10 to 400 parts by weight of homopolystyrene, rubber-modified polystyrene, or a combination thereof.

### Embodiment 13

The composition of any one of embodiments 1-11, wherein the melt-blended components further comprise 100 to 900 parts by weight of a polyamide.

### Embodiment 14

The composition of any one of embodiments 1-11, wherein the melt-blended components further comprise 20 to 400 parts by weight of ethylene homopolymer, propylene homopolymer, or a combination thereof.

### Embodiment 15

The composition of any one of embodiments 1-14, wherein the melt-blended components further comprise 10 to 400 parts by weight of a hydrogenated block copolymer of an alkenyl aromatic monomer and a conjugated diene.

### Embodiment 16

The composition of embodiment 1, wherein the melt-blended components further comprise 5 to 300 parts by weight of an unfunctionalized ethylene/alpha-olefin copolymer, a maleic anhydride-functionalized ethylene/alpha-olefin copolymer, or a combination thereof; and 10 to 200 parts by weight of an unfunctionalized hydrogenated block copolymer of an alkenyl aromatic monomer and a conjugated diene, a maleic anhydride-functionalized hydrogenated block copolymer of an alkenyl aromatic monomer and a conjugated diene, or a combination thereof.

### Embodiment 17

An article comprising the composition of any one of embodiments 1-16.

### Embodiment 18

A method of reducing the odor of a poly(phenylene ether) composition, the method comprising melt blending 100 parts by weight of a poly(phenylene ether), and 0.1 to 4 parts by weight of a phosphate salt selected from the group consisting of sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates; wherein all parts by weight are based on 100 parts by weight of the poly(phenylene ether).

### Embodiment 19

The method of embodiment 18, wherein the phosphate salt is selected from the group consisting of zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates.

### Embodiment 20

The composition of embodiment 18, wherein the phosphate salt is zinc bis(dihydrogen phosphate) (Zn(H₂PO₄)₂), a hydrate thereof, or a combination of the foregoing salt and the hydrate.

All ranges disclosed herein are inclusive of the endpoints, and the endpoints are independently combinable with each other. Each range disclosed herein constitutes a disclosure of any point or sub-range lying within the disclosed range.

The invention is further illustrated by the following non-limiting examples.

### EXAMPLE 1, COMPARATIVE EXAMPLES 1 AND 2

These examples illustrate odor reduction by incorporation of a phosphate salt in a poly(phenylene ether) composition. Components used to form the inventive and comparative compositions are summarized in Table 1.

TABLE 1

| Component | Description |
|---|---|
| PPE | Poly(2,6-dimethyl-1,4-phenylene ether), CAS Reg. No. 24938-67-8, having |
| | an intrinsic viscosity of about 0.46 deciliter per gram as measured in chloroform at |
| | 25° C.; obtained as PPO 646 from SABIC. |
| HIPS | High-impact polystyrene (rubber-modified polystyrene), CAS Reg. No. 9003-55-8, |
| | having a rubber content of 10 weight percent; obtained as PS ET60 from Idemitsu. |
| LLDPE | Linear low density polyethylene, CAS Reg. No. 25087-34-7, having a melt flow rate |
| | of about 20 grams per 10 minutes at 190° C. and 2.16 kilogram load; obtained as |
| | LLDPE M200024 from SABIC. |
| TBPP | Tris(2,4-di-tert-butylphenyl) phosphite, CAS Reg. No. 31570-04-4; obtained as |
| | IRGAFOS ™ 168 from BASF Corp. |
| Citric acid | Citric acid, CAS Reg. No. 77-92-9; obtained from Chem-Supply Pty. Ltd. |
| MZP | Mono zinc phosphate (zinc bis(dihydrogen phosphate), |
| | Zn(H₂PO₄)₂), CAS Reg. No. 13598-37-3; obtained as Z 21-82 |
| | from Budenheim. |

Compositions were compounded in a twin-screw extruder operating at zone temperatures of 50° C., 180° C., 225° C., 245° C., and 255° C. from feed throat to die, a screw rotation rate of 450 rotations per minute, and a throughput of about 30 kilograms per hour. All components were added at the feed throat of the extruder. The extrudate was cooled and pelletized. Pellets were conditioned for four hours at 80° C. prior to use for injection molding.

Injection molding was conducted using zone temperatures of 240° C., 250° C., 250° C., and 250° C. from feed throat to nozzle, a mold temperature of 40° C., an injection speed of 25 millimeters per second, a holding pressure of 600 kilogram force per square-centimeter, and a maximum injection pressure of 1000 kilogram force per square-centimeter.

Each composition was evaluated for the following properties. Odor was subjectively evaluated on a scale of 0 to 5, with 0 corresponding to no odor, and 5 corresponding to a strongly offensive odor. The evaluation was conducted on three kilograms of pellets that had been sealed in a polyethylene bag for six minutes immediately after extrusion and pelletization. For each sample, odor was evaluated by two people, and their ratings were averaged. Melt flow rate was determine according to ASTM D1238-13 using Procedure B, a temperature of 300° C., and a load of 10 kilograms. Flexural properties were determined according to ASTM D790-15e2 at a temperature of 23° C. using bar cross-sectional dimensions of 6.35 millimeters by 12.7 millimeters, a support span of 50 8 millimeters, and a test speed of 1.27 millimeters per minute (0.05 inch/minute). Tensile properties were determined according to ASTM D638-14 at 23° C. using a Type I bar, a gage length of 50 millimeters, and a test speed of 50 millimeters/minute. Notched Izod impact strength values were determined according to ASTM D256-10e1 at 23° C. using bar cross-sectional dimensions of 3.2 millimeters by 12.7 millimeters and a pendulum energy of 6.8 Joules. Heat deflection temperature values were determined according to ASTM D648-16 using bar cross-sectional dimensions of 6.35 millimeters by 12.7 millimeters, and a loading fiber stress of 1.82 megapascals.

Compositions and properties are summarized in Table 2, where component amounts are in parts by weight based on 100 parts by weight poly(phenylene ether). Comparative Example 1, with no odor control agent, exhibited the highest odor rating of 5, corresponding to a strongly offensive odor. Comparative Example 2, containing citric acid as an odor control agent, exhibited an only slightly better rating of 4.5. Example 1, containing a phosphate salt, exhibited a substantially lower rating of 2.5. Physical and thermal properties were similar for the three compositions.

TABLE 2

| | | |
|---|---|---|
| C. Ex. 1 | C. Ex. 2 | Ex. 1 |

COMPOSITIONS

| | | | |
|---|---|---|---|
| PPE | 100.00 | 100.00 | 100.00 |
| HIPS | 48.48 | 48.48 | 48.48 |
| LLDPE | 2.27 | 2.27 | 2.27 |
| TBPP | 0.76 | 0.76 | 0.76 |
| Citric acid | 0.00 | 0.38 | 0.00 |
| MZP | 0.00 | 0.00 | 0.38 |

PROPERTIES

| | | | |
|---|---|---|---|
| Odor rating | 5 | 4.5 | 2.5 |
| Melt flow rate (g/10 min) | 3.3 | 2.9 | 2.9 |
| Flexural modulus (MPa) | 2260 | 2240 | 2220 |
| Flexural strength at yield (MPa) | 89 | 88 | 88 |
| Tensile modulus (MPa) | 2268 | 2283 | 2281 |
| Tensile strength at yield (MPa) | 65 | 65 | 65 |
| Tensile strength at break (MPa) | 52 | 52 | 52 |
| Tensile elongation at break (%) | 15.7 | 15.7 | 17.7 |
| Notched Izod impact strength (J/m) | 159 | 166 | 156 |
| Heat deflection temperature (° C.) | 140 | 141 | 143 |

1. A composition comprising the product of melt blending components comprising:
100 parts by weight of a poly(phenylene ether), and 0.1 to 4 parts by weight of a phosphate salt selected from the group consisting of sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates;
wherein all parts by weight are based on 100 parts by weight of the poly(phenylene ether).

2. The composition of claim 1, wherein the poly(phenylene ether) comprises repeating structural units having the formula 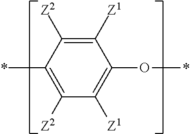
wherein each occurrence of Z¹ is independently halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms; and each occurrence of Z² is independently hydrogen, halogen, unsubstituted or substituted C₁-C₁₂ hydrocarbyl provided that the hydrocarbyl group is not tertiary hydrocarbyl, C₁-C₁₂ hydrocarbylthio, C₁-C₁₂ hydrocarbyloxy, or C₂-C₁₂ halohydrocarbyloxy wherein at least two carbon atoms separate the halogen and oxygen atoms.

3. The composition of claim 1, wherein the poly(phenylene ether) comprises a homopolymer or copolymer of monomers selected from the group consisting of 2,6-dimethylphenol and 2,3,6-trimethylphenol.

4. The composition of claim 1, wherein the poly(phenylene ether) comprises a maleic anhydride-functionalized poly(phenylene ether).

5. The composition of claim 1, wherein the phosphate salt is selected from the group consisting of zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates.

6. The composition of claim 1, wherein the phosphate salt is zinc bis(dihydrogen phosphate) (Zn(H₂PO₄)₂), a hydrate thereof, or a combination of the foregoing salt and the hydrate.

7. The composition of claim 1, wherein the melt-blended components further comprise 0.1 to 5 parts by weight of maleic anhydride.

8. The composition of claim 1, wherein the melt-blended components further comprise 5 to 400 parts by weight of a maleic anhydride-functionalized ethylene/alpha-olefin copolymer.

9. The composition of claim 8, wherein the melt-blended components further comprise 5 to 400 parts by weight of an unfunctionalized ethylene/alpha-olefin copolymer.

10. The composition of claim 1, wherein the melt-blended components further comprise 5 to 400 parts by weight of a maleic anhydride-functionalized hydrogenated block copolymer of an alkenyl aromatic monomer and a conjugated diene.

11. The composition of claim 10, wherein the melt-blended components further comprise 10 to 400 parts by weight of an unfunctionalized hydrogenated block copolymer of an alkenyl aromatic monomer and a conjugated diene.

12. The composition of claim 1, wherein the melt-blended components further comprise 10 to 400 parts by weight of homopolystyrene, rubber-modified polystyrene, or a combination thereof.

13. The composition of claim 1, wherein the melt-blended components further comprise 100 to 900 parts by weight of a polyamide.

14. The composition of claim 1, wherein the melt-blended components further comprise 20 to 400 parts by weight of ethylene homopolymer, propylene homopolymer, or a combination thereof.

15. The composition of claim 1, wherein the melt-blended components further comprise 10 to 400 parts by weight of a hydrogenated block copolymer of an alkenyl aromatic monomer and a conjugated diene.

16. The composition of claim 1, wherein the melt-blended components further comprise
5 to 300 parts by weight of an unfunctionalized ethylene/alpha-olefin copolymer, a maleic anhydride-functionalized ethylene/alpha-olefin copolymer, or a combination thereof; and
10 to 200 parts by weight of an unfunctionalized hydrogenated block copolymer of an alkenyl aromatic monomer and a conjugated diene, a maleic anhydride-functionalized hydrogenated block copolymer of an alkenyl aromatic monomer and a conjugated diene, or a combination thereof.

17. An article comprising the composition of claim 1.

18. A method of reducing the odor of a poly(phenylene ether) composition, the method comprising melt blending
100 parts by weight of a poly(phenylene ether), and
0.1 to 4 parts by weight of a phosphate salt selected from the group consisting of sodium dihydrogen phosphate (Na(H₂PO₄)), disodium pyrophosphate (Na₂(H₂P₂O₇)), potassium dihydrogen phosphate (K(H₂PO₄)), dipotassium pyrophosphate (K₂(H₂P₂O₇)), calcium hydrogen phosphate (Ca(HPO₄)), calcium bis(dihydrogen phosphate) (Ca(H₂PO₄)₂), magnesium hydrogen phosphate (Mg(HPO₄)), magnesium bis(dihydrogen phosphate) (Mg(H₂PO₄)₂), zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates;
wherein all parts by weight are based on 100 parts by weight of the poly(phenylene ether).

19. The method of claim 18, wherein the phosphate salt is selected from the group consisting of zinc phosphate (Zn₃(PO₄)₂), zinc hydrogen phosphate (Zn(HPO₄)), zinc bis(dihydrogen phosphate) (Zn(H₂PO₄)₂), a hydrate of one of the foregoing salts, or a combination of at least two of the foregoing salts and hydrates.

20. The composition of claim 18, wherein the phosphate salt is zinc bis(dihydrogen phosphate) (Zn(H₂PO₄)₂), a hydrate thereof, or a combination of the foregoing salt and the hydrate.
